(19) United States
(12) Patent Application Publication
(10) Pub. No.: US 2007/0012795 A1
(43) Pub. Date: Jan. 18, 2007

(54) Cleaning device and method

(76) Inventor: Bertil Eliasson, Vallda (SE)

Correspondence Address: GAUTHIER & CONNORS, LLP, 225 FRANKLIN STREET, SUITE 2300, BOSTON, MA, 02110, US

(21) Appl. No.: 11/523,829

(22) Filed: Sep. 20, 2006

Related U.S. Application Data
(62) Division of application No. 11/009,684, filed on Dec. 10, 2004, now abandoned.
Application No. 11/009,684 is a continuation of application No. PCT/SE03/01034, filed on Jun. 16, 2003.

(30) Foreign Application Priority Data
Jun. 16, 2002 (SE) 0201900-8

(51) Int. Cl. B05B 17/04; B05B 7/16

(52) U.S. Cl. 239/13; 239/128

(57) ABSTRACT

The present invention relates to a device for the extermination of pests like e.g., worms and arthropods such as insects and wood-louses, mites, etc., wherein said device is provided with a nozzle arranged to distribute carbon dioxide in solid state to create an atmosphere comprising of carbon dioxide and wherein said nozzle is adapted to achieve a predetermined particle size and velocity of said carbon dioxide adapted for the geometry the pest is located into and wherein the particle size and the velocity are optimized for an effective extermination of the pest in question. The invention also relates to methods and compositions for use with said devices.

### TECHNICAL FIELD

The present invention relates to a device for the extermination of pests such as for example worms and arthropods; such as insects and wood-louses, mites, etc., using carbon dioxide of a controlled particle size. The invention also relates to a methods and a composition for use with said device.

### BACKGROUND OF THE INVENTION

Disinfection by cooling is a well-documented method (Skytte, T. “Bekaempelse af museumskadedyr ved nedfrysning” Naturhistorisk museum, rhus 1993). The efficiacy is increased if the temperature is allowed to fall very rapidly to very low temperatures. The velocity of the temperature decrease and the achieved minimal temperature are both essential criteria that must act in order to obtain a safe disinfection.

Indoor insects often settles in locations exhibiting of complicated geometries. Some of these areas are not possible to disinfect using conventional methods due to poison related risks or because they are out of reach for treatment.

Potential problems associated with conventional chemicals include degradation products, residual products, allergic reactions and a probable enrichment of harmful substances in the food chain. Some gases, e.g., carbon dioxide does not cause any of these problems.

U.S. Pat. No. 4,200,656 discloses a method for fumigating grain stored in bins, by applying mixture of liquid carbon dioxide and methyl bromide to the upper layer of the grain. This method is hazardous to the health since methyl bromide is used.

U.S. Pat. No. 5,394,643 discloses a process for extermination of nest-building, tunnel digging insects such as ants or other ground-living insects using carbon dioxide in order to suffocate them.

U.S. Pat. No. 4,413,756 discloses equipments for the extermination of insects, wherein a cold gas such as carbon dioxide is delivered and wherein the insects are killed due to the low temperature.

EP 0 823 214 describes the use of carbon dioxide in a solid, dry, aggregated state as cooling agent for the extermination of small animals in textile materials.

The problem using the known methods is that they do not describe an economical and environmental friendly approach seen from a production point of view, since they do not define the connection between how the cooling is performed and how carbon dioxide shall be delivered to obtain an optimal result.

### SUMMARY OF THE INVENTION

The object of the present invention is to provide a device for the extermination of pests like e.g., worms and arthropods such as insects and wood-louses, mites, etc. especially in equipment and spaces for food production. This object is solved by providing a device provided with a nozzle arranged to distribute carbon dioxide in solid state to create an atmosphere comprising of carbon dioxide and wherein said nozzle is adapted to achieve a predetermined particle size and velocity of said carbon dioxide adapted for the geometry the pest is located into and wherein the particle size and the velocity are optimised for an effective extermination of the pest in question.

According to yet a further aspect of the invention, a device is provided for the extermination of pest such as for example insects and wood-louses, mites, etc., comprising the following steps: a) to first subject the pest for an atmosphere which entirely or partly is comprised of carbon dioxide during a predetermined time period, and then b) cool the pest to a temperature equally to or lower than a critical temperature Tₖᵣᵢₜ, wherein Tₖᵣᵢₜ is defined as the temperature wherein the pest is on the limit of freezing to death and/or respond with an increase of the body temperature.

Further, according to another aspect of the invention a composition is provided for the extermination of pests comprising carbon dioxide in a solid state having a determined particle size adapted for the kind of pest that is to be exterminated and for the geometry said pest is located into.

According to yet another aspect of the invention the use of carbon dioxide in a solid state is provided of a predetermined particle size for the manufacture of a composition arranged to effectively exterminate certain kinds of pests in a certain kind of determined geometry.

According to yet a further aspect of the invention, a method is provided for extermination of pests such as for example worms and arthropods such as insects and wood-louses, mites, etc., comprising of the following steps: a) to first cool the pest to a temperature equally to or lower than a critical temperature Tₖᵣᵢₜ, wherein Tₖᵣᵢₜ is defined as the temperature wherein the pest is on the limit of freezing to death and/or respond with an increase of the body temperature, and then b) subject the pest for an atmosphere which entirely or partly is comprised of carbon dioxide during a predetermined time period which kill said pest.

Further characteristics of the invention would be apparent from the dependent claims and the following description.

### SHORT DESCRIPTION OF THE DRAWINGS

The invention will in the following be closer described with reference to the embodiments shown on the enclosed drawings.

FIG. 1 schematically shows the temperature in the pest during the time period the animal has been cooled down to the critical temperature Tₖᵣᵢₜ.

FIG. 2 shows a cooling test in a tube.

FIG. 3 shows a cooling test in a wedge.

FIG. 4 shows a cooling test on a planar surface.

FIG. 5 shows a further cooling test in a tube.

### DETALJERAD BESKRIVNING AV INVENTION

Insects exhibit different physiological mechanisms to endure and survive low temperatures. One mechanism is to decrease the freezing point by producing anti freeze agents such as sugars, alcohols and proteins. Another mechanism is to induce the formation of ice between the cells and thereby protect them. Some insects respond to low temperatures by generating heat being induced by proteins. The commonly present yellow meal worm, Tenebrio molitor, has the capability to increase its temperature almost 10° C., when it is subjected to a temperature decrease.

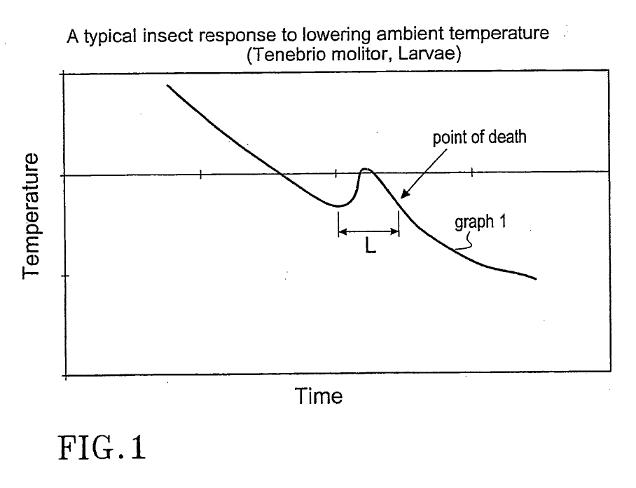

The phenomena which form the basis for the present invention is discovery that pests such as insects upon cooling down to the critical temperature Tₖᵣᵢₜ leads to an increase of the temperature inside the insect. Tₖᵣᵢₜ is thus defined as the temperature where said pest is on the limit of freezing to death and/or is responding with an increase of the body temperature. Table A shows examples of Tₖᵣᵢₜ for different species. At Tₖᵣᵢₜ is the insect partly frozen and is on the edge of life and death. It can be noted that also insects frozen to death has been observed to exhibit an increase of the temperature but the increase is not as significant. The temperature increase is energy demanding and makes the animal consume more oxygen than normal after a close to death experience. The recovery when the temperature increases and the animal no longer is frozen leads to an enhanced respiration. This panting makes the animal more receptive for a gaseous treatment FIG. 1 shows a typical insect response on a lower ambient temperature (Tenebrio molitor, larvae). The insect can emit heat (L in the figure). If the temperature decreases very rapidly then the insect will emit less heat, resulting in a more rapid extermination.

TABLE A
Examples of critical temperatures for a selection of pests.
(T. Skytte, 1993)

| Specie | Egg (° C.) | Larvae (° C.) | Puppa (° C.) | Adult animal (° C.) |
|---|---|---|---|---|
| Anobuim punctatum | −28 | | | −19.2 |
| Anthrenus flavipes | | −26.2 | | −22.3 |
| Anthrenus museorum | | −27.3 | | |
| Anthrenus verbasci | −27.8 | −27.0 | −23.5 | −20.6 |
| Attagenus smirnovi | | −25.3 | | −22.3 |
| Attagenus woodroffei | | −24.0 | −18.5 | −20.8 |
| Demestes haemorrhoidalis | −26.2 | −26.3 | | |
| Demestes lardarius | | −18.2 | | |
| Hylotrupes bajulus | | −26.9 | | |
| Lasiderma serricorne | −28.8 | −26.2 | −25.3 | −20.2 |
| Oryzaephilus surinamesis | | | | −20.8 |
| Ptinus tectus | | −26.8 | | −23.7 |
| Reesa vespulae | | −25.1 | | −23.1 |
| Stegobium paniceum | | −24.0 | | −24.0 |
| Tenebrio molitor | −25.8 | −24.7 | −21.3 | −14.3 |
| Tinea pellionella | −33.4 | −23.1 | −23.5 | −23.1 |
| Tineola bisselliella | −29.8 | −28.1 | −25.6 | −24.0 |
| Tribolium confusum | | −24.3 | | −20.2 |
| Tribolium destructor | | −20.8 | | −22.0 |

The method according to the invention for the extermination of pests first comprise cooling of the pest to a temperature equally to or lower than a critical temperature Tₖᵣᵢₜ, and then subject the pest for an atmosphere which entirely or partly comprises of carbon dioxide during a predetermined time period which kills said pest. The cooling to the critical temperature is performed using a controlled velocity and it is important that the cooling is performed relatively fast. Preferred cooling velocity can be between 1 and 400° C./s, preferably 50° C./s.

Cooling to the critical temperature is performed using carbon dioxide in solid state, so-called carbon dioxide snow. The application of carbon dioxide is preferably performed using a device provided with a nozzle arranged to distribute carbon dioxide in solid state and where said nozzle is adapted to achieve a predetermined particle size for said carbon dioxide and a predetermined velocity adapted for an effective en extermination of the pest in question. The carbon dioxide can exhibit a particle size of between about 0.02 and 3 mm, preferably between about 0.05 and 2 mm. Thus, the carbon dioxide can exhibit a particle size between 0.02 till 3 mm, preferably 0.05 to 2 mm on a distance of about 0.2 m from the pest and the velocity of the particles can be selected within the range of 0.5-200 m/s, preferably 5-125 m/s.

The atmosphere of carbon dioxide can contain 100% carbon dioxide, but also atmospheres containing 30-99% carbon dioxide, preferably 50-95% are very effective. The carbon dioxide atmosphere can be pulsed with air.

The method is suitable for the extermination of pests located in spaces intended for food production, in cooling chambers and containers intended for the refinement of grain such as mills. The method is also well suited for the pest control indoor in spaces where humans and animals reside. Worms and arthropods such as insects and wood-louses, mites, etc., in all kinds of stages such as eggs, pupa, larvae and as fully developed animals, are denoted as pests. The methods according to the present invention can also be used for the extermination of bacterial.

Carbon dioxide is a toxic gas to insects, which not only acts through pure suffocation due to the absence of oxygen but also exhibits a toxic effect per se. An increased respiration frequency, which is reached upon cooling down to the critical temperature of an atmosphere which entirely or partly leads to an increased uptake and distribution of carbon dioxide to the animal body and thereby a toxic effect of carbon dioxide. The reduced movablity of the insects upon the cooling makes the treatment with carbon dioxide more effective. In addition, a repeated treatment will be more effective for the animals located in the edge portions of the treatment, since the insects that did not die have a worse response since they already are weakened due to the initial treatment.

Said protection mechanisms above, exhibited by the pests are energy consuming and time consuming. It is therefore important to cool rapidly. Det är därför det är s\dot{a} viktigt att kyla fort. The faster the temperature is decreased; the better is the obtained result. The method according to the invention effectively exterminates insects and larvae and also eggs, although insect eggs are much more endurable than larvae and adult insects.

Carbon dioxide has the advantage that it does not leave residual products behind, it is readily available and can be delivered in many package sizes. The normal production can proceed during the entire process. Limitation due to toxic chemical method is totally avoided using the method according to the invention. Additionally, the use of carbon dioxide also allows direct contact with the food and can be used in the entire equipment. Consequently, there is no reason to evacuate personnel during the cleaning-up. The method according to the present invention also requires a minimum of protection clothing for the operator.

Upon the handling of grain or similar handling the need for preparatory cleaning steps are reduced since the cooled carbon dioxide mixture blend itself with flour without aerosol formation as compared to the use of compressed air. This makes the method well suited for integration in present hygiene and cleaning routines.

Carbon dioxide is generated as byproducts upon manufacture of ammonia and hydrogen. Other sources are common fermentation processes and lime burning. Since the carbon dioxide already is manufactured, no further carbon dioxide is delivered to the atmosphere.

The method according to the present invention could also be used for houses, animal stables or the like where the requirements on poison free methods increases.

Example 1 describes cooling tests using different kinds of nozzles in different kinds of geometries. The aim of the tests was to create a knowledge basis for the construction of nozzles for carbon dioxide cleaning-up having a sufficient cooling ability, wherein the extermination effect per amount used gas is satisfactory and to investigate the requirements for an effective extermination in geometries representing the environments present in food industry.

The food industry consists of many materials forming many structures where insects can live and multiply. In the present tests models have been constructed for the purpose of investigating the cooling ability for different nozzles, which deliver carbon dioxide snow having different velocities and particle size.

The single factor deciding which snow quality of the carbon dioxide snow that is most suitable, is how much heat energy the surface can deliver to the sublimation of the carbon dioxide snow. Thus, a heat-isolated surface becomes very cold whilst other surfaces will require other snow qualities for a rapid cooling. The reason for this is the gas layer formed and which hinders the penetration of the snow particles to the surface. Since this layer has been shown to act hindering a couple of millimeters above the surface, the insects can be protected from the cooling.

Except for the nature of the target surface, the cooling effect is determined of the particle size, velocity, angle of impact and hit intensity. The cleaning distance also affect the result since the particles sublime and/or lump together during the ride between the nozzle and the target. Also the velocity of the particles is changed when the distance is changed.

The four nozzles tested provide snow having different particle size and velocity and exhibits different cooling effects depending on the nature of the target. For each target one snow quality has been shown to be better than the other. One nozzle providing all snow qualities would be desirable to always obtain the most rapid cooling in different geometries.

According to the invention a device is presented for the extermination of pests, that said device is provided with a nozzle arranged to distribute carbon dioxide in solid state and wherein said nozzle is adapted to achieve a predetermined particle size and velocity of said carbon dioxide adapted for the geometry the pest reside into and wherein the particle size and the velocity is optimized for an effective extermination of the pest in question. Preferably, the particle size and the particle velocity can be regulated for the solid carbon dioxide in said nozzle for adaptation to different geometrical conditions and for different kinds pests. This will lead to the need for only one nozzle for many applications.

In one embodiment the device can comprise of one 2 mm syringe with CO₂ in liquid phase to a valve. From the valve three smaller syringes (approx. 0.7 mm.) leads to a cylindrical snow-forming chamber (approx. 13×125 mm). Thanks to the construction of the valve, CO₂ can be let into one, two or all three syringes to the nozzle. By letting different amounts of liquid to the snow-forming chamber, the particle size as well as the velocity can be varied.

In another embodiment the device can first subject the pest for an atmosphere which entirely or partly consist of carbon dioxide during a predetermined time period, and then cool the pest to a temperature which is lower than a critical temperature Tₖᵣᵢₜ, wherein Tₖᵣᵢₜ is defined as the temperature where the pest in question is on the edge of freezing to death and/or respond with an increase of the body temperature.

Cooling to the critical temperature is performed using carbon dioxide in solid state, wherein the carbon dioxide can have a particle size of between 0.02 and 3 mm, preferably 0.05 to 2 mm on a distance from the pest of about 0.2 m and the particle size can be selected within the range of 0.5-200 m/s, preferably 5-125 m/s. The atmosphere of carbon dioxide can contain 100% carbon dioxide, but also contents of men 30-99% carbon dioxide, preferably 50-95% are preferred. The carbon dioxide can also be pulsed with air.

The devices according to the invention are suitable for extermination of pests present in spaces intended for food production, in cooling chambers, tubings and containers intended for refinement of grain such as e.g., mills. The method is also well suited for indoor pest control in places where humans or animals reside. As pest is e.g., worms or arthropods such as insects and wood-louses, mites, etc., in all stages such as eggs, pupa, larvae and as fully developed animals, denoted. The devices according to the present invention can also be used for the extermination of bacteria.

Within the scope of the invention, a composition for the extermination of pests is provides comprising carbon dioxide in solid state having a predetermined particle size and particle velocity adapted for the type of pests that is being exterminated and for the geometry said pest reside into.

The carbon dioxide can exhibit a particle size of between 0.02 and 3 mm, preferably 0.05 till 2 mm on a distance from the pest of about 0.2 m and the particle velocity is selected with in the range of 0.5-200 m/s, preferably 5-125 m/s.

The composition according to the invention is suitable for the extermination of pests being present in spaces intended for food production, in cooling chambers, tubings and containers intended for refinement of grain such as e.g., mills. The method is also well suited for indoor pest control in places where humans or animals reside. As pest is e.g., worms or arthropods such as insects and wood-louses, mites, etc., in all stages such as eggs, pupa, larvae and as fully developed animals, denoted. The composition according to the present invention can also be used for the extermination of bacteria.

In addition, the use of carbon dioxide in solid state having a predetermined particle size and particle velocity for the manufacture of a composition arranged to effectively exterminate a certain kind of pest in certain geometries. The carbon dioxide in the composition can exhibit a particle size of between 0.02 and 3 mm, preferably 0.05 till 2 mm, on a distance from the pest of about 0.2 m and the particle velocity is selected with in the range of 0.5-200 m/s, preferably 5-125 m/s.

Of one used nozzles providing an extremely high particle velocity, a high pressure syringe could be used, e.g., for a poison free housecleaning or cleaning of spaces, where spraying of carbon dioxide particles having an extremely high velocity could remove dirt and dust from these spaces.

In food industry, especially in mills is spaying with compressed air is the poison free and reliable method to clean spaces. It suffers from several disadvantages such as distribution of allergenic compounds, mould spores and insect eggs. However, many observations have significantly shown that compressed air whirls up large amounts of flour and other contaminants in air in comparison to carbon dioxide. Also from a working environmental point of view, it is inappropriate to inhale the aerosols mentioned above when using compressed air. Many workers employed in food industry suffer from problems with for example flour allergy.

The carbon dioxide, being a heavy gas, effectively brings the flour particles or particulate contaminants down to the floor where the mixture easily can be removed by means of e.g., sweeping. The use of carbon dioxide for these applications effectively solves the above problems.

A device according to the invention can be provided with nozzles or syringes, from which gaseous carbon dioxide or carbon dioxide in solid state effectively without cooling can flush away flour and other contaminants that could be integrated in the process equipment of for instance a food processing plant. This would provide for an effective cleaning on the location in question in the food processing plant, e.g., in tubings and different kinds of containers and vessels. Since the aerosol formation is significantly reduced in comparison to the use of compressed air, the carbon dioxide can provide a cleaning action beside the effect caused by cooling. The insects and other pests, mould and bacteria consequently lose their feedstock due to the cleaning and this leads to an improved hygienic standard within the food processing plant.

The devices according to the invention could also be movable to several locations within the food processing plant.

The cleaning effect can be varied dependant on the conditions on the location in question. If more care is to be taken on sensitive places due to allergenic contamination, lower velocities of the gas or the solid particles of carbon dioxide can be used, for example 40 m/s. Depending on the conditions on the location, other particle and gas velocities can be selected to accomplish both cooling of the spaces in question and/or provide a blasting effect on the surfaces.

A velocity of about 80-125 m/s could be a suitable range to obtain both freezing of the insects and pests and erosion of undesired accumulation of flour, fat, or the like. If necessary one could use velocities close to the speed of sound, which can be present close to the outlet syringe for carbon dioxide. It may also be advantageous to further increase the pressure and thereby the velocity, for example by blending the mixture with another gas or in another way. The carbon dioxide can exhibit a particle size of between 0.02 and 3 mm, preferably 0.05 till 2 mm on a distance from the target of about 0.2 m and the particle velocity is selected with in the range of 0.5-200 m/s, preferably 5-125 m/s.

The eroding effect on surfaces can be increased in that outlet openings or nozzles can be assembled in bindles in order to better cover the surface that is to be treated. It is also possible to let one or more outlet openings rotate. The outlet opening can rotate for themselves and/or many outlet openings could rotate around each other. This enhances the eroding effect and provide for an improved covering/freezing of the surfaces and/or volumes surrounded by these surfaces.

The invention shall not be limited to just food processing plants but can provide an efficient, poison-free cleaning of any suitable target especially targets having complicated geometrical structures that are hard to reach.

Experimental Section

The invention will now be closer described with reference to the following non-limiting examples.

Cooling Tests Using Different Nozzles in Different Kinds of Geometries

The aim of the tests was firstly to create a knowledge basis for the construction of nozzles for cleaning up using carbon dioxide having a sufficient cooling ability, wherein the extermination effect per amount used gas is satisfactory and secondly to investigate the requirements for an effective extermination in geometries representing the environments present in food industry.

The four nozzles tested provide a carbon dioxide snow having different particle sizes and velocities and exhibits different cooling efficiency depending on the nature of the target. For each target one snow quality has been proven to be better than the other. It would be desirable to have one nozzle providing all snow qualities in order to always obtain the fastest cooling in different geometries. The nozzle P2:1 provides a relatively large size of the carbon dioxide snow with a relatively low particle velocity. The nozzle P2:3 provides a smaller size of the carbon dioxide snow and a higher particle velocity than P2:1. The nozzle P2:3+tube is the P2:3 nozzle provided with a tube, which provide a nozzle having a particle velocity being between the velocity for P2:1 and P2:3, but approximately equally large particles as for P2:3 without tube. The nozzle P1:1 provides a relatively smaller particle size and particle velocity than the other nozzles.

Four different geometries have been investigated. The application of carbon dioxide snow has been performed using different nozzles. The distances, angles and spraying times and have been varied and is presented under results. The measure data have been created using thin machine soldered thermo elements having a weight close to an insect.

### EXAMPLE 1

Tests in a Double Bended Tube of Stainless Steel.

The tube has a internal diameter of 45 mm and a goods thickness of 4 mm. The total length is about 2.5 m. The first 90° bend is located 1.87 m on the tube and the other bend is bended 90° 0.5 m after the first bend. The tube is turned so that the first bend is faced upwards. The thermo elements are brought on plastic pieces on the internal surface exhibiting the distances of 0.215 m and 0.870 m from the inlet of the straight portion of the tube. The third thermo element was brought just after the first bend and the fourth thermo element in the second bend. The thermo elements were denoted K1, K3, K9 and K11.

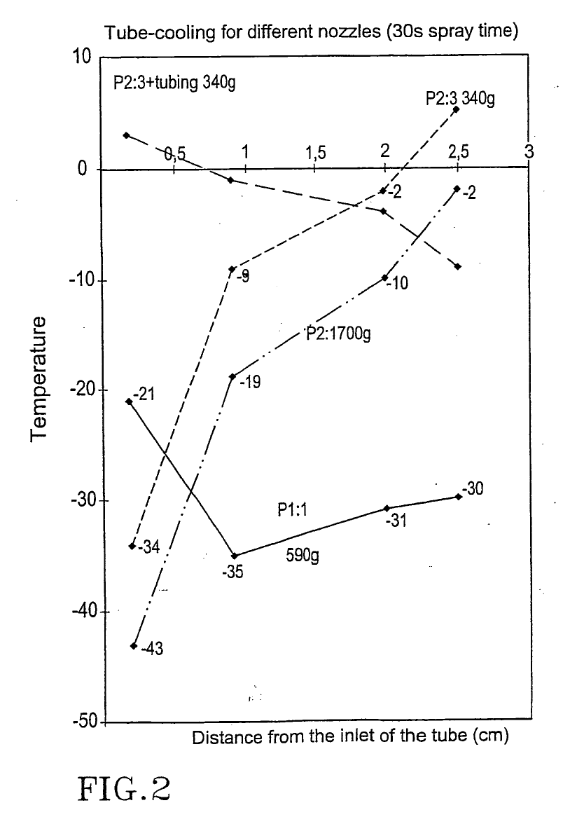

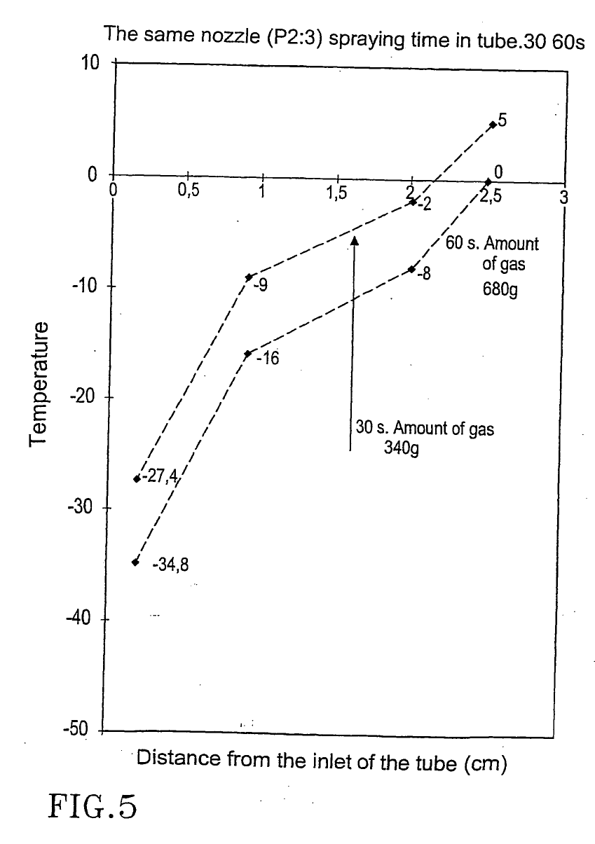

Tables 1-7 below show cooling inside tubes. FIG. 2 is a graph showing cooling inside a tube for the different nozzles at different distances from the opening of the tube. FIG. 5 shows the comparison between a nozzle, P2:3, at different spraying times.

TABLE 1
Represents cooling inside tubes. Nozzle P1:1. Spraying time 30 s.
The nozzle is put about 30 mm inside the tube.
Used amount of gas 590 g.

| | | Minimum | Temperature | ° C./used |
|---|---|---|---|---|
| Measure | Starting | temperature | change | amount |
| point | temperature ° C. | ° C. | ° C. | of gas (g) |
| K1 | 4 | −21 | 25 | 0.042 |
| K3 | 9 | −35 | 44 | 0.075 |
| K9 | 21 | −31 | 52 | 0.088 |
| K11 | 23 | −30 | 54 | 0.092 |

Extermination achieved in all measure points except for the first.

TABLE 2
Represents cooling inside tubes. Nozzle P2:1. Spraying time 30 s.
The nozzle is put about 30 mm inside the tube (no air is sucked in).
Used amount of gas 700 g.

| | Starting | | Temperature | ° C./ |
|---|---|---|---|---|
| Measure | temperature | Minimum | change | used amount |
| point | ° C. | temperature ° C. | ° C. | of gas (g) |
| K1 | 21 | −43 | 64 | 0.091 |
| K3 | 13 | −19 | 32 | 0.047 |
| K9 | 18 | −10 | 28 | 0.040 |
| K11 | 23 | −2 | 25 | 0.036 |

It can be noted that a lot of condense is formed when the snow is present in the tube.

TABLE 3
Represents cooling inside tubes. Nozzle P2:1. Spraying time 30 s.
Nozzle is put about - 0 mm inside the tube (air is sucked in).
Used amount of gas 700 g.

| | Starting | Minimum | Temperature | |
|---|---|---|---|---|
| Measure | temperature | temperature | change | ° C./used amount |
| point | ° C. | ° C. | ° C. | of gas (g) |
| K1 | 15 | −46 | 61 | 0.153 |
| K3 | 20 | −15 | 35 | 0.071 |
| K9 | 24 | −8 | 32 | 0.057 |
| K11 | 23 | −6 | 29 | 0.050 |

A comparison between table 2 and 3 gives a small change, but a small improvement can be noted deep inside the tube. Condense is formed.

TABLE 4
Represents cooling inside tubes. Nozzle P2:3. Spraying time 30 s.
Nozzle is put about 30 mm inside the tube.
Used amount of gas 340 g.

| | Starting | Minimum | Temperature | |
|---|---|---|---|---|
| Measure | temperature | temperature | change | ° C./used amount |
| point | ° C. | ° C. | ° C. | of gas (g) |
| K1 | 23 | −34 | 57 | 0.172 |
| K3 | 22 | −9 | 31 | 0.091 |
| K9 | 23 | −2 | 25 | 0.074 |
| K11 | 24 | 5 | 19 | 0.056 |

TABLE 5
Represents cooling inside tubes. Nozzle P2:3. Spraying time 60 s.
Nozzle is put about 30 mm inside the tube. Used amount of gas 680 g.

| | Starting | Minimum | Temperature | |
|---|---|---|---|---|
| Measure | temperature | temperature | change | ° C./used amount |
| point | ° C. | ° C. | ° C. | of gas (g) |
| K1 | 16 | −16 | 32 | 0.047 |
| K3 | 19 | −27 | 46 | 0.068 |
| K9 | 22 | −8 | 30 | 0.044 |
| K11 | 25 | 0 | 25 | 0.037 |

TABLE 6
Represents cooling inside tubes. Nozzle P2:3 + 2 m tube U8.
Spraying time 30 s. Nozzle is put about 30 mm inside the tube.
Air follow into the tube. Used amount of gas 340 g.

| | Starting | Minimum | Temperature | |
|---|---|---|---|---|
| Measure | temperature | temperature | change | ° C./used amount |
| point | ° C. | ° C. | ° C. | of gas (g) |
| K1 | 22 | 3 | 19 | 0.056 |
| K3 | 23 | −1 | 24 | 0.071 |
| K9 | 23 | −4 | 27 | 0.079 |
| K11 | 24 | −9 | 33 | 0.097 |

TABLE 7
Represents cooling inside tubes. Nozzle P2:3 + 2 m tube U8.
Spraying time 30 s. The nozzle is put about 30 mm inside the tube.
Air is not following into the tube. Used amount of gas 340 g.

| | Starting | Minimum | Temperature | |
|---|---|---|---|---|
| Measure | temperature | temperature | change | ° C./used amount |
| point | ° C. | ° C. | ° C. | of gas (g) |
| K1 | 22 | 5 | 17 | 0.050 |
| K3 | 23 | 15 | 8 | 0.024 |
| K9 | 23 | 15 | 8 | 0.024 |
| K11 | 22 | 17 | 5 | 0.015 |

It can be noted in connection to table 6 and 7 that the cooling is ineffective for all measure points. It might be due to that the snow has too low velocity.

### EXAMPLE 2

Tests in a Wedge.

Two aluminium panels 400 mm×100 mm are brought against each other as to form a wedge having an opening of 1 mm on top and 0 mm in the bottom. The panel thickness is 1 mm. The panels belly outwards a bit when they are subjected for the pressure of the carbon dioxide. The thermo elements are brought on the surface without contact with the panel in recessed holes 3 mm. The lower and the upper measure point are brought 5 mm from the respective edge and the third in the middle. The measure points are denoted K1, K3 and K9 from the surface to the bottom.

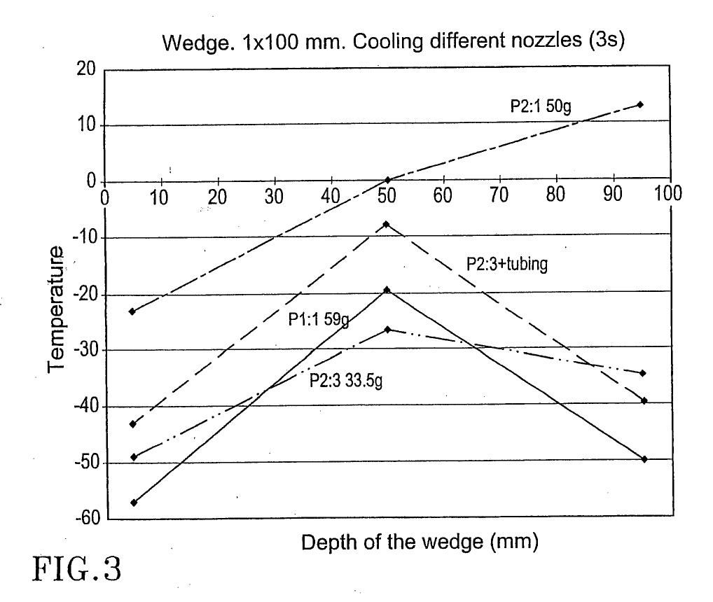

The Tables 8-11 below show cooling in a wedge. FIG. 3 is a graph showing cooling in a wedge for the different nozzles at different depths in said wedge.

TABLE 8
Cooling in a wedge. Nozzle P1:1. Distance 60 mm, from the side.
The wedge is mounted having its longitudinal axis vertically arranged.
Spraying time 3 seconds. Starting temperature approx. 25° C.
Amount of gas 59 g.

| | | | ° C./ |
|---|---|---|---|
| Measure | Minimum | Temperature change | used amount of gas |
| point | temperature ° C. | ° C. | (g) |
| K1 | −57 | 82 | 1.39 |
| K3 | −20 | 45 | 0.76 |
| K9 | −50 | 75 | 1.27 |

TABLE 9
Cooling in a wedge. Nozzle P2:1. Distance 60 mm, from above.
The wedge is mounted having its longitudinal axis vertically arranged.
Spraying time 3 seconds. Starting temperature about 22° C.
Amount of gas 72.5 g.

| | Minimum | Temperature | |
|---|---|---|---|
| Measure | temperature | change | ° C./used amount of gas |
| point | ° C. | ° C. | (g) |
| K1 | −23 | 45 | 0.62 |
| K3 | 0 | 22 | 0.30 |
| K9 | +13 | 9 | 0.12 |

TABLE 10
Cooling in a wedge. Nozzle P2:3. Distance 60 mm, from above. The
wedge is mounted having its longitudinal axis vertically arranged.
Spraying time 3 seconds. Starting temperature about 22° C.
Gas consumed 33.5 g.

| | Minimum temperature | Temperature | ° C./used amount |
|---|---|---|---|
| Measure point | ° C. | change ° C. | of gas (g) |
| K1 | −43 | 65 | 1.94 |
| K3 | −8 | 30 | 0.90 |
| K9 | −40 | 62 | 1.85 |

TABLE 11
Cooling in a wedge. Nozzle P2:3 + 2 m steel reinforced silicon
tubing having a woven layer (U8). Distance 60 mm, from above. The
wedge is mounted having its longitudinal axis vertically arranged
Spraying time 3 seconds. Starting temperature about
22° C. Amount of gas 33.5 g.

| | Minimum temperature | Temperature | ° C./used amount |
|---|---|---|---|
| Measure point | ° C. | change ° C. | of gas (g) |
| K1 | −49 | 71 | 2.11 |
| K3 | −27 | 49 | 1.46 |
| K9 | −35 | 57 | 1.70 |

The best cooling result is obtained spraying is performed perpendicularly to the crack. The optimal distance depends on the velocity of the snow and the particle size, but the test show that it is advantageous to keep the tested nozzles close to the cleft.

### EXAMPLE 3

Tests on a Planar Surface.

An aluminium panel having the dimensions of 30×30×0.5 mm was provided with a thermo element that was adhesively joined to the surface in one of the corners. The panel was heat insulated by applying a cell rubber tape on the back.

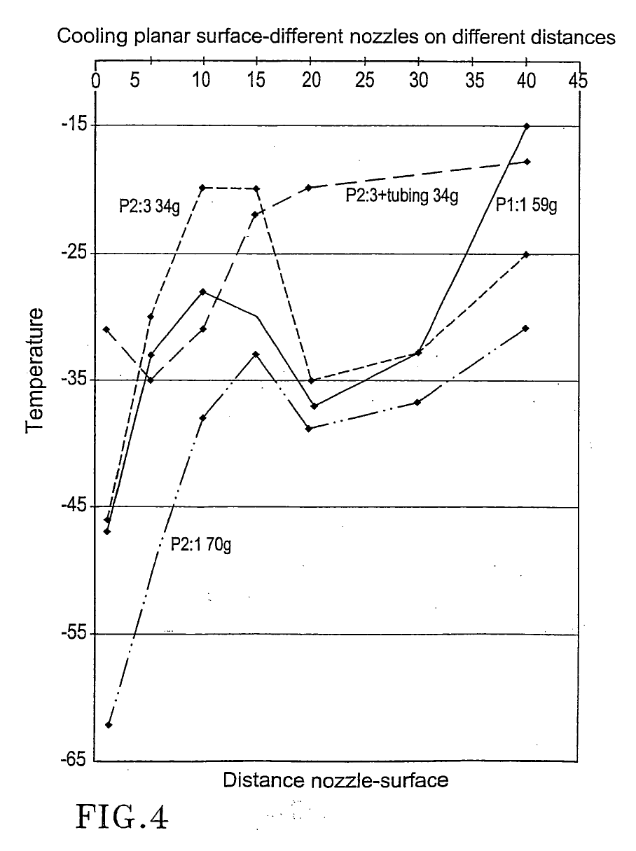

The Tables 12-15 show cooling on a planar surface. The cooling effect for different kinds of nozzles on different distances from the target Table 16 shows cooling of a planar surface. Same nozzle but at different spraying times. FIG. 4 is a graph showing cooling on a planar surface for the different nozzles at different distances from said nozzle and the planar surface.

TABLE 12
Cooling on a planar surface. Nozzle P2:3. Distance 1, 5, 10, 15,
20, 30 and 40 cm. Spraying time 3 s. Target: isolated aluminium
panel. Starting temperature about 25° C. before a new application.
Used amount of gas 34 g.

| Distance nozzle- | Obtained minimum | Temperature | ° C./used amount |
|---|---|---|---|
| target (cm) | temperature ° C. | change | of gas (g) |
| 1 | −46 | 71 | 2.08 |
| 5 | −30 | 55 | 1.61 |
| 10 | −20 | 45 | 1.32 |
| 15 | −20 | 45 | 1.32 |
| 20 | −35 | 60 | 1.76 |
| 30 | −33 | 58 | 1.71 |
| 40 | −25 | 50 | 1.47 |

It can be noted that the extermination is worse on the distances 10 and 15 cm.

TABLE 13
Cooling on a planar surface. Nozzle P1:1. Distance 1, 5, 10,
15, 20, 30 and 40 cm. 3 s spraying time. Target: isolated aluminium
panel. Starting temperature about 25° C. before a new
application. Used amount of gas 59 g.

| Distance nozzle- | Obtained minimum | Temperature | ° C./used amount |
|---|---|---|---|
| target (cm) | temperature ° C. | change ° C. | of gas (g) |
| 1 | −47 | 72 | 1.22 |
| 5 | −33 | 58 | 1.00 |
| 10 | −28 | 53 | 0.91 |
| 15 | −30 | 55 | 0.93 |
| 20 | — | — | — |
| 30 | −33 | 58 | 1.00 |
| 40 | −15 | 40 | 0.75 |

One measure point is missing. It means that the critical distance for the nozzle is either 30 or 40 cm. If the time is increased to 10 s the minimum temperature is increased to −65° C. The temperature change is 90° C. and the efficiency is 90/118=0.76. It is thus effective to increase the spraying time to more than 3 s. On a 40 cm distance −40° C. is achieved after 10 s and −67° C. when pulsed spraying 10+15 s.

TABLE 14
Cooling on a planar surface. Nozzle P2:1. Distance 1, 5, 10,
15, 20, 30 and 40 cm. 3 s spraying time. Target: isolated aluminium
panel. Starting temperature about 25° C. before a new
application. Used amount of gas 70 g.

| Distance nozzle- | Obtained minimum | Temperature | ° C./used amount |
|---|---|---|---|
| target (cm) | temperature ° C. | change | of gas (g) |
| 1 | −62 | 87 | 1.24 |
| 5 | −50 | 75 | 1.07 |
| 10 | −38 | 63 | 0.9 |
| 15 | −33 | 58 | 0.8 |
| 20 | −39 | 64 | 0.91 |
| 30 | −37 | 62 | 0.88 |
| 40 | −31 | 56 | 0.80 |

An overall good extermination temperature.

TABLE 15
Cooling on a planar surface. Nozzle P2:3 + 2 m steel reinforced
silicon tubing having a woven layer (U8). Distance 1, 5, 10, 15,
20, 30 and 40 cm. 3 s spraying time. Target: isolated aluminium
panel. Starting temperature about 25° C. before new
application. Used amount of gas 34 g.

| | | | ° C./used |
|---|---|---|---|
| Distance nozzle- | Obtained minimum | Temperaturändring | amount |
| target (cm) | temperature ° C. | ° C. | of gas (g) |
| 1 | −31 | 56 | 1.67 |
| 5 | −35 | 60 | 1.76 |
| 10 | −31 | 56 | 1.65 |
| 15 | −22 | 47 | 1.38 |
| 20 | −20 | 40 | 1.17 |
| 30 | −19 | 39 | 1.15 |
| 40 | −18 | 38 | 1.12 |

TABLE 16
Cooling on a planar surface. The spraying times are varied. The
other conditions are kept constant. Nozzle P2:3 + 2 m steel reinforced
silicon tubing having a woven layer (U8). Spraying time 3, 5, 10, and
15 s. Target: isolated aluminium panel. Distance 20 cm. Starting
temperature about 25° C. before new application.
Used amount of gas 34 g.

| | Used amount | Obtained | Temperature | ° C./used |
|---|---|---|---|---|
| Spraying | of | minimum | change | amount of |
| time (s) | gas (g) | temperature ° C. | ° C. | gas (g) |
| 3 | 34 | −19 | 44 | 1.29 |
| 5 | 56 | −30 | 55 | 0.98 |
| 10 | 113 | −40 | 65 | 0.58 |
| 15 | 170 | −48 | 73 | 0.43 |

Snow is building up in layers in all four cases. For the best consumption of gas it is important to not spray for to long. However, the cooling is increased during time. The gas pressure contributes to keep the thickness of the gas layer down that is being formed by the snow and hinders the energy transfer. This effect is probably more pronounced when the velocity of the snow is higher.

### EXAMPLE 4

Tests on a Planar Isolated Surface.

The aluminium panel from Example 3 above was provided with a 10 mm thick cell rubber layer whereupon a planar thermo element was attached.

Table 17 shows cooling of an isolated surface using cell rubber and Table 18 shows cooling of the thermo element above covered with a cardboard sheet to simulate the effect from a flour layer.

TABLE 17
Cooling of a isolated surface covered with cell rubber. Nozzle
P2:3 + 2 m steel reinforced silicon tubing having a woven layer (U8).
Spraying time 3, 5, 10, and 15 s. Target: thermo element on a
cell rubber surface. Distance: 20 cm. Starting temperature about
22° C. before a new application Used amount of gas 34 g.

| Spraying | Used amount | Obtained minimum |
|---|---|---|
| time (s) | of gas (g) | temperature ° C. |
| 3 | 34 | −79 |
| 5 | 56 | −79 |
| 10 | 113 | −80 |
| 15 | 170 | −80 |

It can be noted that the longer the spraying time the longer it would take for the snow to fall off. This makes long spraying times unnecessary.

TABLE 18
Test of a cardboard sheet. (about 20 × 20 mm) adhesively
joined on top of a isolated thermo element. Spraying time 3 s. Distance
about 30 cm. Reconditioning to about 20° C. between the tests.

| | With | | |
|---|---|---|---|
| | cardboard | Obtained minimum | |
| Nozzle | or not | temperature ° C. | Remarks |
| P1:1 | with | −67 | Long distance for this snow |
| P1:1 | without | −76 | Long distance for this snow |
| P2:1 | with | −60 | |
| P2:1 | without | −74 | |
| P2:3 | with | −48 | |
| P2:3 | without | −60 | |
| P2:3 with | with | −77 | |
| tube | | | |
| P2:3 with | without | −78 | |
| tube | | | |

Nozzle P2:3 with tube is the outstanding nozzle.

The invention shall not be regarded as being limited to the embodiments and examples shown in the description but should be interpreted within the scope of the appended claims.

1-22. (canceled)

23. A method according to claim 33, wherein the application of carbon dioxide is performed using a device provided with a nozzle arranged to distribute carbon dioxide in solid state and wherein said nozzle is adapted to achieve a predetermined particle size of said carbon dioxide and a predetermined velocity adapted for an effective extermination of the pests in question.

24. A method according to claim 33, wherein the carbon dioxide exhibits a particle size of between 0.02 and 3 mm.

25. A method according to claim 33, wherein said carbon dioxide exhibits a particle size between 0.02 and 3 mm, preferably 0.1 and 2 mm on a distance from the pest in question of about 0.2 m and the particle velocity is selected within the range of 0.5-200 m/s, preferably 5-125 m/s.

26. A method according to claim 33, wherein said atmosphere of carbon dioxide contain 100% carbon dioxide.

27. A method according to claim 33, wherein said atmosphere of carbon dioxide contains 30-99% carbon dioxide, preferably 50-95%.

28. A method according to claim 33, wherein said atmosphere of carbon dioxide is pulsed together with air.

29-32. (canceled)

33. A method for the for a poison free housecleaning or cleaning of spaces, where spraying of carbon dioxide particles having an extremely high velocity is applied to remove dirt and dust from these space.

34. A method according to claim 33, wherein said cleansing takes place in spaces intended for household.

35. A method according to claim 33, wherein an eroding effect on surfaces is obtained in that outlet or nozzles are assembled in bindle in order to cover the surface to be treated.

36. A method according to claim 35, wherein the outlet opening is arranged to rotate for themselves and/or a number of outlet openings are arranged to rotate around each other.
